(19) United States
(12) Patent Application Publication
(10) Pub. No.: US 2007/0271998 A1
(43) Pub. Date: Nov. 29, 2007

(54) Apparatus for testing the emissions, content or permeability of materials

(75) Inventor: Elizabeth Angela Woolfenden, Glynogwr (GB)

Correspondence Address: TUMEY, L.L.P., P.O. BOX 22188, HOUSTON, TX, 77227-2188, US

(73) Assignee: Markes International Limited, Rhondda Cynon Taff (GB)

(21) Appl. No.: 11/441,769

(22) Filed: May 26, 2006

(51) Int. Cl. G01N 15/08

(52) U.S. Cl. 73/38

(57) ABSTRACT

An apparatus for testing the emissions, content or permeability of samples of materials, comprises at least two sample chambers (5a,5b), each in communication with a receiver (9a,9b) for a sorbent trap (10a,10b), a gas inlet conduit (2) having at least two gas delivery conduits (3a,3b), arranged to deliver gas to respective sample chambers, and at least two gas-flow impedance devices (4a,4b), arranged to control the flow of gas through respective sample chambers and through respective sorbent traps. The gas-flow impedance devices preferably comprise a body of porous material and serve to ensure that the rate of flow of gas is substantially the same through each and every sample chamber, regardless of whether a given sample chamber is in use, with a sorbent trap in place or not, or if different sorbent traps are in use for the different sample chambers.

The present invention is concerned with apparatus for use in materials emissions and/or content testing and/or permeation testing.

Materials emissions testing is a process whereby a sample to be tested is placed in a special chamber and is fed with a controlled flow of pure air/gas. The air sweeps over the surface of the sample thereby carrying away organic vapours emitted by the sample. The exhaust air/gas containing the organic vapours is then collected by pumping a fixed volume onto sorbent tube technology at a controlled flow rate. The retained vapours are then subsequently analysed by thermal desorption with GC-MS/FID (Gas Chromatography-Mass Spectrometry/Flame Ionization Detection) using standard CEN (European Committee for Normalisation) and ISO (International Standards Organisation) procedures. The tested products/materials receive a certificate or label to categorise them according to their emissions.

A disadvantage of the procedure is that it is complicated, lengthy (standard methods require pure air to flow through conventional (e.g. cubic metro) sample chambers for 72-hours after the sample has been inserted before vapours are sampled onto sorbent traps) and subject to many variables. Therefore, a majority of certification/labelling schemes require manufacturers to send their samples to an accredited third party lab for certification tests. These sorts of emissions tests are not permitted ‘in-house’. This is, of course, expensive and means that formal certification testing is usually only required to be carried out annually or even tri-annually. However, many regulators and the manufacturers themselves want a more simple, inexpensive, alternative type of emissions test that can be carried out by production quality control laboratories in between formal certification tests to make sure the quality stays uniform. It is also desirable for manufacturers to carry out ‘in-house’ tests on prototype materials and products and to compare them with materials or products of their competitors.

It is desirable for testing apparatus to include two or more sample chambers to allow parallel testing of multiple samples thus boosting laboratory productivity and reducing costs. However, it is essential that the flow into each chamber is controlled and that the air flow through sorbent traps, which are, in communication with each sample chamber, is also controlled. Conventional apparatus uses mass flow controllers, fans or needle valves to control the air flow into sample chambers and additional pumps with needle valves or mass flow controllers to control the air flow through attached sorbent traps. Any excess flow of air/gas that enters the sample clamber but is not pumped/passed through the sorbent trap is allowed to exhaust to vent. However, such apparatus is both expensive and results in complicated equipment. In addition, the sampling flow has to be corrected/calibrated for each individual sorbent trap/pump combination.

It is therefore an aim of the present invention to provide an apparatus which will allow multiple samples to be tested in multiple sample chambers simultaneously but without some of the disadvantages identified above.

In accordance with the present invention, there is provided an apparatus for testing the emissions, content or permeability of materials, the apparatus comprising:
at least two sample chambers, each being in communication with a sorbent trap receiver;
a gas inlet conduit having at least two gas delivery conduits, arranged to deliver gas to respective said sample chambers; and
at least two gas-flow impedance devices arranged to control the flow of gas through respective said sample chambers and through respective sorbent traps disposed in said sorbent trap receivers. It is preferred that tins invention applies to situations where the sorbent trap receivers are attached and when there is no alternative gas outlet on the sample chamber.

An important feature of the invention is the use of a gas-flow impedance device, the inherent structure of which allows for control of both inlet gas-flow and outlet gas flow through a sorbent trap, when attached and when there is no alternate gas outlet on the chamber. This is preferable to using separate and relatively complex devices such as fans, mass flow controllers and pumps, which themselves have to be controlled.

The gas-flow impedance devices preferably serve to ensure that the rate of flow of gas is substantially the same through each and every sample chamber, regardless of whether a given sample chamber is in use with a sorbent trap in place, or not, or different sorbent traps are connected to different sample chambers: typically therefore, the impedance presented by the impedance device is substantially greater than the remaining impedance of the path downstream of the impedance device, i.e. the sample chamber and sorbent trap. Thus, the flow rate through each and every sample chamber will be substantially the same and will remain the same irrespective of whether or not a sorbent trap is attached and irrespective of the impedance presented by its specific sorbent trap (within a normal operating range). In essence, the total impedance through the impedance device is much greater than that in the rest of the system such that any change in the impedance of the rest of the system has negligible impact on the flow into the chamber and through the sorbent traps.

Each of the gas-flow impedance devices creates a uniform impedance at a given gas pressure so that the flow of gas through each of the individual sample chambers is substantially the same.

It is desirable that the restriction/impedance of the flow across the gas-flow impedance device is at least 10 and preferably at least 20 times greater than the impedance of flow across the sample chamber for example, with a sorbent trap attached. This means that the flow through an individual sample chamber, such as a microchamber will not change significantly (typically by more than 5%) when a sorbent trap is attached to the sorbent trap receiver on the outlet of the sample chamber. This also means that the flow of gas through each of the sample chambers remains the same, whether or not a sorbent trap is attached. This avoids the need for flow regulation of the supply of air/gas to each sample chamber. If there is no alternate outlet for the air/gas from (be sample chamber it also avoids the need for pumps plus associated flow regulation for the sampling of air/gas from the sample chamber onto sorbent traps. The user simply needs to supply air to the system at a fixed and constant pressure in order to ensure a constant flow of air to each sample chamber and through each sorbent trap when they are attached. This makes the system easier to regulate, easier to use and less costly to manufacture.

Typically, a sample chamber of the apparatus, with a sorbent trap attached, according to embodiments of the invention has an impedance maximum of 1 Psi when there is a gas flow rate of 100 ml/mn.

Preferably each gas-flow impedance device comprises a body of porous material and may conveniently comprise a frit (which usually comprises a scintered disc of metal or glass material having fine pores through it).

Instead, the gas-flow impedance may comprise a restrictor tube, that is to say a length of narrow-bore tubing the length and diameter of which are selected to provide the required impedance to gas-flow.

According to a first embodiment of the present invention, the gas-flow impedance device is positioned upstream of its sample chamber, such that the gas flows through the gas delivery conduit, the impedance device and subsequently through the sample chamber and its sorbent trap (if attached and if there is no alternate gas outlet from the sample chamber).

According to a second embodiment of the present invention, the gas-flow impedance device is positioned downstream of the sorbent trap, such the gas flows through the sample chamber, the sorbent trap and subsequently through the impedance device. This embodiment of the invention would only work if there is no alternate outlet for the air/gas from the sample chamber.

Preferably, the apparatus includes three or more gas delivery conduits, three or more sample chambers and three or more sorbent trap receivers. It is, of course, envisaged that the apparatus may include more than three gas delivery conduits, sample chambers and sorbent trap receivers.

It is further envisaged that each sample chamber may be connected to two or more sorbent trap receivers. Advantageously, each sorbent trap receiver may receive sorbent traps having different packings (and therefore different impedances).

It is particularly preferred that the gas-flow impedance device, where this is a frit or other body of porous material, is not positioned in the flow path between the sample chamber and the sorbent trap, as any organic material extracted in the gas from the sample in the sample chamber would contaminate the frit and also may be held by the frit thereby preventing all of the extracted sample from reaching the sorbent trap.

The apparatus may further include heating means arranged to heat or maintain the sample chamber at a predetermined temperature.

The sample chambers or vessels may be of stainless steel, aluminium, PTFF, glass or some other inert, non-emitting, non-adsorbing material.

The sample chambers or vessels may be of any size including very small (<50 ml volume micro-chambers) as this reduces sample equilibration times, speeding up emissions testing from 72 hours to significantly less than one hour.

The gas delivery conduits preferably comprise tubing typically having a flow path 1/16 inch×0.5 mm bore. Preferably the tubing is of stainless steel, aluminium, PTFE, glass or some other inert, non-emitting, non adsorbing material.

Preferably, the sample chambers have polished internal surfaces.

During use of the apparatus, it is particularly preferred that a one-way valve or diffusion locking mechanism is attached to an outlet on the sorbent trap; a suitable diffusion locking mechanism would be the cap disclosed in UK patent GB2359070. However, it is, of course, envisaged that other diffusion locking mechanisms may be used in the apparatus according to the present invention. The use of such diffusion locking mechanisms or one-way valves is desirable to substantially prevent air or other gasses flowing back into the sorbent trap if the flow of air through the sample chamber it is connected to is temporarily stopped.

The present invention will now be described by way of examples only, with reference to the accompanying drawings, wherein:

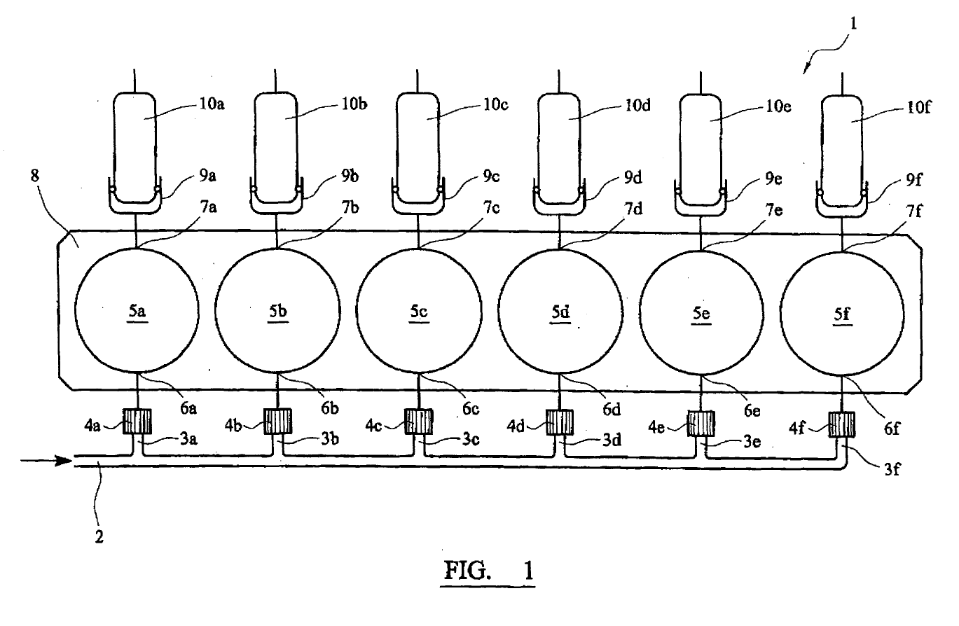

FIG. 1 is a diagram of an apparatus in accordance with the present invention, for use in testing the emissions, content or permeability of materials; and

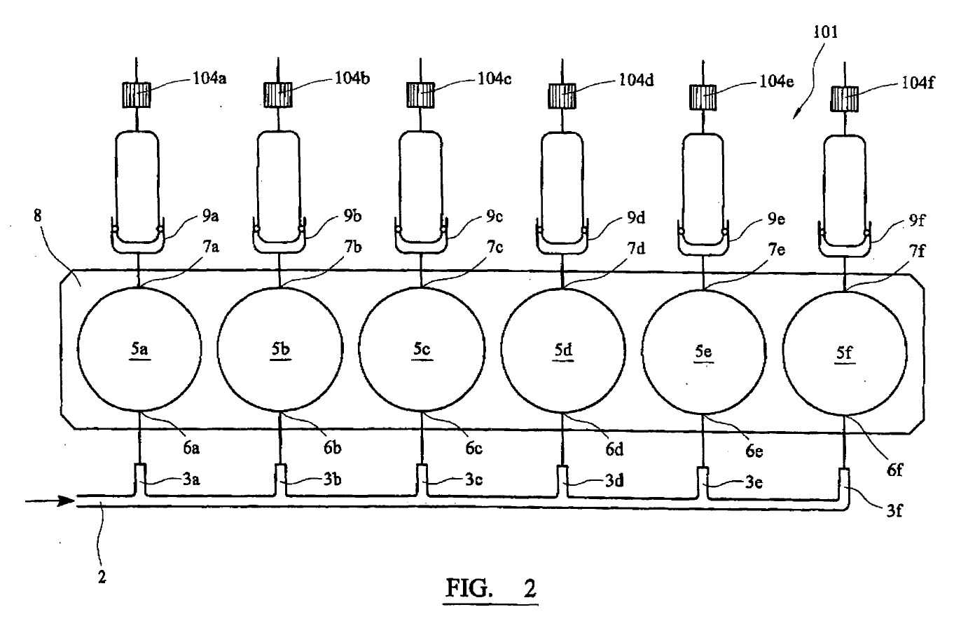

FIG. 2 is a similar diagram of a modification of the apparatus shown in FIG. 1.

Referring to FIG. 1, there is shown an apparatus generally represented by the numeral 1 and comprising a gas inlet conduit 2 which splits into six gas delivery conduits 3a to 3f. Positioned in the gas delivery conduits 3a to 3f are respective frits 4a to 4f. The gas delivery conduits deliver gas to respective lidded stainless steel sample chambers 5a to 5f having gas inlet ports 6a to 6f and gas outlet ports 7a to 7f. The sample chambers 5a to 5f are placed in a heated aluminium block 8. The outlet ports 7a to 7f are connected to sorbent trap receivers 9a to 9f having respective sorbent traps 10a to 10f fitted sealingly therein.

In use of the apparatus 1 for material emissions and/or content testing, a sample to be analysed is positioned in one or more sample chamber 5a to 5f and sealed therein. A flow of air is introduced into the apparatus 1 via inlet conduit 2. The gas diffuses through the delivery conduits 3a to 3f and through the respective frits 4a to 4. The frits regulate the flow of air such that the rate of flow of gas into the different sample chambers 5a to 5f is substantially the same as each other. Analytes or organic volatiles, if present, are emitted from the samples and the air containing the extracted analytes then passes through the outlets 7a to 7f and into the respective sorbent traps for detection.

In use of the apparatus for permeability testing, a sample of the test material, in generally sheet form, is stretched across the top of a permeation accessory which comprises a well in which a test compound is disposed: the sample of test material is sealed around the perimeter of the permeation accessory and then this placed inside one of the sample chambers 5a to 5f. Clean air/gas is then passed through the sample chambers, as described above: any material emitted by the test compound, and permeating through the sample of test material, is carried by the air/gas flow, into the respective sorbent trap 10a to 10f, for detection. The permeability of the sample to the test compound is thus tested.

Referring to FIG. 2 where like numerals have been used represent like parts, there is shown an apparatus represented by the numeral 101, which differs from the apparatus 1 of FIG. 1, in that the frit 104 is positioned in the gas flow after or downstream of the sorbent trap 110.

The invention is intended to cover not only single embodiments described, but also combinations of the described embodiments for example multiple sample chambers with an alternate air/gas outlet such that air/gas can pass both to the sorbent traps and to vent. In this case the restrictor devices may only control the flow of air/gas into each sample chamber not through the sorbent trap.

It is to be understood that modifications and variations of the present invention will become apparent to those skilled in the art and it is intended that all such modifications will be included within the scope of the present invention as claimed.

1. An apparatus for testing the emissions, content or permeability of materials, the apparatus comprising:
at least two sample chambers, each being in communication with a sorbent trap receiver;
a gas inlet conduit having at least two gas delivery conduits, arranged to deliver gas to respective said sample chambers; and
at least two gas-flow impedance devices, arranged to control the flow of gas through respective of said sample chambers;
wherein said two or more gas-flow impedance devices control the flow of gas through respective sorbent traps disposed in said sorbent trap receivers.

2. An apparatus according to claim 1 for testing the emissions, content or permeability of materials, wherein said two or more gas-flow impedance devices control the flow of gas through respective sorbent traps disposed in said sorbent trap receiver when there is no alternative outlet for the gas except through the sorbent traps.

3. An apparatus according to claim 2, wherein the flow rate through each sorbent trap will be substantially the same irrespective of the number of sample chambers in the apparatus that have sorbent traps disposed in their respective sorbent trap receivers.

4. An apparatus as claimed in claim 1, in which each said impedance device comprises a body of porous material.

5. An apparatus according to claim 4, wherein the body of porous material comprises a frit.

6. An apparatus as claimed in claim 1, in which each said impedance device comprises a restrictor tube.

7. An apparatus as claimed in claim 1, in which said gas-flow impedance devices are disposed upstream of the respective said sample chambers.

8. An apparatus as claimed in claim 1, wherein said gas-flow impedance devices are arranged to be disposed downstream of the respective said sorbent traps.

9. Art apparatus according to claim 1, wherein the impedance presented by the respective gas-flow impedance devices is substantially greater than the total impedance of a path through the sample chamber and the sorbent trap downstream of each respective impedance device.

10. An apparatus according to claim 9, wherein an impedance of flow of the material prior to entering each of said sample chambers is between 10 and 20 times that of the impedance of the material as it passes through the sample chamber.

11. Apparatus according to claim 1 including heating means arranged to heat or maintain each sample chamber at a predetermined temperature.

12. An apparatus according to claim 1, wherein the flow rate through each sample chamber will be substantially the same irrespective of the impedance or said sample chamber and irrespective of whether or not a sorbent trap is disposed in one or more of said sorbent trap receivers.

13. Apparatus according to claim 1, wherein the sample chambers are formed of an inert material.

14. Apparatus according to claim 1, wherein a one-way valve or diffusion locking mechanism is attached to an outlet on the sorbent trap.

15. A method of testing for emissions, content or permeability of materials wherein a sample is fed to at least two sample chambers, each being in communication with a sorbent trap receiver; with gas being delivered to respective of said sample chambers by gas delivery conduits, the gas being delivered to said gas delivery conduits by a gas inlet conduit, with the flow of gas through said respective sample chambers being controlled by at least one gas flow impedance device situated in each of said sample chambers, said gas also being caused to pass through respective sorbent traps in said sorbent trap receivers, to all sample chambers with substantially no impact occurring on the air flow through respective chambers.

16. A method according to claim 15, wherein the impedance presented by the respective gas-flow impedance devices is substantially greater than the total impedance of a path through the sample chamber and the sorbent trap downstream of each respective impedance device.

17. A method according to claim 15, wherein impedance of flow of the gas is between 10 and 20 times that which passes through the sample chamber.

18. A method according to claim 15, wherein the flow rate through each sample trap is substantially the same irrespective of the impedance presented by its respective sorbent trap.

19. A method of testing for emissions, content or permeability of materials according to claim 15 wherein each gas-flow impedance device is positioned upstream of a respective sample device.

20. A method of testing for emissions, content or permeability of materials according to claim 15, wherein each gas flow impedance device is positioned downstream of a respective sample device.

21. A method according to claim 15, wherein gas is caused to flow through two or more sorbent traps in a chamber, which have different impedances.

22. A method according to claim 15, wherein the sample chamber is heated.

23. A method according to claim 15, wherein a one-way valve is in communication with an outlet on a sorbent trap to substantially prevent air or gases flowing back into the sorbent trap before or after vapour collection.
